(19) United States
(12) Patent Application Publication
(10) Pub. No.: US 2018/0077960 A1
(43) Pub. Date: Mar. 22, 2018

(54) FLAVOR COMPOSITION

(71) Applicant: Givaudan S.A., Vernier (CH)

(72) Inventor: Stephen Geoffrey FENIMORE, Cincinnati, OH (US)

(21) Appl. No.: 15/268,881

(22) Filed: Sep. 19, 2016

(51) Int. Cl. A23L 27/00

(52) U.S. Cl. CPC A23L 27/80; A23V 2002/00; A23L 27/72; A23L 27/77

(57) ABSTRACT

Water-soluble dried particles are provided. The water-soluble dried particles include a water-soluble matrix; and a plurality of droplets having an average size of from about 3 μm to about 15 μm. The droplets include at least one volatile active component having an average clogP value of at least 2; and a plurality of hydrophobically modified particulate materials including (i) core particulate material and (ii) a hydrophobic ingredient. The water-soluble dried particles exhibit a surface oil level of less than 0.3%.

### TECHINCAL FIELD

The present disclosure relates to water-soluble solids including an encapsulated mixture of volatile ingredients and methods of producing such solids. More particularly, the present disclosure relates to solid products including large droplets in a water-soluble matrix, the droplets including at least one volatile active component and at least one hydrophobically modified particulate material.

### BACKGROUND

Encapsulating volatile components in a solid encapsulating matrix is a well-known method. The advantages are numerous and include, for example, (i) the protection of the volatile component against undesired evaporation during storage, (ii) the protection of chemically sensitive components against chemical degradation, such as oxidation and hydrolysis, and (iii) the possibility to control the release of the encapsulated component.

Numerous methods can be used to produce solids comprising encapsulated volatile ingredients. For example, a melt of thermoplastic polymer in which the volatile active has been dissolved or dispersed is extruded and subsequently cooled below the glass transition of the mixture. Alternatively, the volatile component is added to a melted wax and the mixture cooled below the melting point of the mixture and shaped in the desired form. These methods have in common that the volatile active component is either molecularly dissolved in the material or undergoes partial or total phase separation, which often results in the formation of uncontrolled oily domains, which once exuded from the material lead to high levels of surface oil. However, when the volatile component is hydrophobic, as it is the case of most flavors and fragrance ingredients, the solid material may be glassy and polar and the volatile component may be dispersed in the material in the form of distinct droplets which are not or minimally soluble in the matrix.

Drop processes are also known, where the volatile active is admixed with a gel-forming material to form a solid, which may be injected or sprayed in the form of drops or droplets into a medium comprising a cross-linking agent, resulting typically in 0.5 to 1000 millimeter-sized particles. Alternatively, a medium comprising the volatile component can be co-extruded with an encapsulating matrix in a co-axial extruder to a vibrating nozzle where drops of volatile component-containing carrier material.

However, the most common and economical way to encapsulate a volatile component involves the step of emulsifying the volatile component in an aqueous phase comprising encapsulating materials to form an oil-in-water emulsion and drying this emulsion by spray drying, spray granulation or spray coating to obtain a dry emulsion. The morphology of the dry product is that of a multitude of oil droplets in a glassy, polar, encapsulating matrix. The polar, encapsulating matrix is usually based on carbohydrate materials, such as modified starches, maltodextrins, and gums, with sometimes proteins added.

According to the state of the art, the most suitable conditions to encapsulate volatile components by spray drying are met when the size of the oil droplets is below 5 micrometers, in another embodiment below 2 micrometers and in another embodiment below 1 micrometer. This is typically achieved by using macromolecular surface active carbohydrates, such as gum Arabic or starch hydrolysates modified with Octenyl Succinic Anhydride, also known as OSA-starches. It has been observed that such conditions, combined with fast drying rates, were ideal for providing high encapsulation yield and low surface oil, even at high oil volume fractions, also referred to as payload.

When the matrix material dissolves in water, the oil is released in the form of an oil-in-water emulsion, where the size of the oil droplets in the emulsion is about the same as that of the droplets in the matrix.

However, there are many situations, where the combination of small emulsion droplet sizes and fast drying rates are not met. For example, in fluid-bed agglomeration processes, the water activity is maintained at a certain level during the whole agglomeration process in order to impart stickiness to the primary particles. Similarly, in cases the granule growth is achieved by spray coating, water is continuously fed into the system, leading to steady state evaporation at the particle surface. Under such conditions, the glass transition of the matrix drops under the operative conditions and the matrix becomes rubbery. Concomitantly, a loss of volatile active component is often observed, due to migration of the component through this rubbery matrix and its entrainment by the evaporating water. The extent of this undesired phenomenon may increase with decreasing droplet size, owing to the increase of the droplet/matrix interface area. For all these reasons, large droplets may be desired in many cases.

There are also situations, where the volatile component may be released in the form of droplets having number-average sizes larger than 5 to 9 micrometers after dissolution of the matrix in water. Large droplets may provide additional opportunities to better control the release of the volatile component subsequently to the dissolution of the water soluble form, compared to droplets having sizes smaller than 1 to 2 micrometers. For example, the release of the volatile active component may delayed, due to the smaller droplet/water surface area; or, in the contrary, more of the active component may be released at some point of time and under specific trigger, owing to the higher local concentration of volatile component.

There are a number of applications where the release of large volatile component-containing droplets from a water-soluble form would be very useful. For example, the volatile active component may be a flavor component that is aimed to be used in soluble beverages or soups, or any other food application involving the dissolution of a water-soluble form, such as instant juice drinks, instant coffee or tea, snack seasonings, bouillon, instant soup, dehydrated soup, chewing gum, baked goods, dried sauce or gravy, cup/bowl instant noodles, pouch instant noodles, dried food, dessert mixes, herbs and spices, etc. The volatile may also be a fragrance component that is aimed to be released at some point of time after the water-soluble form has been exposed to moisture of contacted with water. For example, solid forms comprising the volatile fragrance component may be added to a solid detergent. When dissolved during the washing process, the solid form dissolves and releases the microencapsulated volatile fragrance component in the wash liquor and the volatile fragrance component is subsequently released from the droplets providing thereby enhanced perfume perception by the consumer. Alternatively, the deposition of the fragrance on inanimate substrate, such as fabrics or hard surfaces, or on animate substrate, such as skin or hair may be enhanced. The volatile component may also be pesticide, a fungicide, a pheromone, and the like.

Accordingly, there remains a need for water-soluble solids including encapsulated mixtures of volatile ingredients having large droplet sizes and releasing large droplets of the mixtures of volatile ingredients in an application.

### SUMMARY

In one embodiment, water-soluble dried particles include a water-soluble matrix; and a plurality of droplets having an average size of from about 3 μm to about 15 μm. The droplets include at least one volatile active component having an average clogP value of at least 2; and a plurality of hydrophobically modified particulate materials including (i) core particulate material and (ii) a hydrophobic ingredient. The water-soluble dried particles exhibit a surface oil level of less than 0.3%.

In another embodiment, a process for preparing water-soluble dried particles includes the steps of a) preparing a plurality of hydrophobically modified particulate materials by mixing core particulate material and a hydrophobic ingredient until a free flowing powder is obtained; b) adding a volatile active component having an average clogP value of at least 2; c) stirring, agitating or mixing the hydrophobically modified particulate materials and the volatile active component until a coarse dispersion is obtained; d) preparing a water-soluble matrix including at least a carbohydrate and water; e) combining the coarse dispersion and the water-soluble matrix under high shear mixing to form an emulsion; and f) drying the emulsion.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to water-soluble dried particles including an encapsulated mixture of volatile ingredients. Water-soluble dried particles according to the present disclosure include the combination of a water-soluble matrix and large droplets, the large droplets having at least one volatile active component and at least one hydrophobically modified particulate material, resulting in particles with low surface oil. This was not expected from the prior art, which teaches that when producing such particles by spray drying, spray coating or fluid bed granulation, the combination of high loads and large droplets generally leads to low encapsulation efficiency and high surface oil. The water-soluble dried particles may also include other optional ingredients for particular applications.

A combination of large droplets and minimal level of surface oil is not possible when using classical emulsifiers, surfactants and protective colloids, such as octenyl succinate modified starch. The low level of surface oil is also a sign that the volatile ingredient(s) are well trapped in the large droplet during drying. As a result, in one embodiment, the oil-in-water emulsion formed according to the present disclosure is particularly suitable as feed emulsion for drying processes involving slow water evaporation rate, such as spray- and fluid-bed coatings, and spray granulation.

Water-soluble dried particles according to the present disclosure have an average size of from about 10 μm to about 250 μm; in another embodiment from about 20 μm to about 200 μm; and in yet another embodiment from about 30 μm to about 150 μm. In one embodiment, the average size of the water-soluble dried particles is at least two times larger than the average size of the droplets in the emulsion.

In one example, a particle may be unregularly shaped and the size of the particle is defined as the mean between the largest diameter of the particle and the smallest diameter of the particle. In another example, a particle may be spherical and the size of the particle is defined as the diameter of the particle. The average size of a collection of particles may be obtained by different methods. For example, the particles may be observed under an optical microscope and the diameters of the particles, or of an arbitrary number of the particles, measured one by one and averaged to provide a number-averaged particle size. Alternatively, a cloud of particles may be measured by light scattering measurements using a Malvern 2000S instrument and the Mie scattering theory. The principle of the Mie theory and how light scattering can be used to measure capsule size can be found, for example H. C. van de Hulst, Light scattering by small particles, Dover, N.Y., 1981. The primary information provided by static light scattering is the angular dependence of the light scattering intensity, which in turn is linked to the size and shape of the particle in the cloud. However, in a standard operation method, the size of a sphere having a size equivalent to the size of the diffracting object, whatever the shape of this object, is calculated by the Malvern proprietary software provided with the apparatus. In case of polydisperse samples, the angular dependence of the overall scattering intensity contains information about the size distribution in the sample. The output is a histogram representing the total volume of capsules belonging to a given size class as a function of the capsule size, whereas an arbitrary number of 50 size classes can be chosen. Light scattering provides a volume-averaged particle size.

The water-soluble dried particles according to the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, confectionery products, baked products, sweet products, savoury products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery , lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfaj ores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products.

The water-soluble dried particles according to the present disclosure may be used in a wide variety of applications besides the food-related consumables mentioned hereinabove. In one embodiment, the water-soluble dried particles may be used in fragrance applications and especially in applications wherein a burst-like fragrance release is desired. There are numerous examples of situations, where such triggered release is desired by consumers. For example, the water-soluble dried particles may be admixed with a powder detergent, and the fragrance released when this mixture is added to water. Alternatively, the water-soluble dried particles may be used everywhere wherein moisture is involved, such as deodorant products, toilet blocs, dish wash tablets, pet litters, diapers and sanitary napkins, feminine hygiene products, mouth hygiene products such as denture cleaning tablets and toothpastes and the like.

In one embodiment, water-soluble dried particles in accordance with the present disclosure may include a water-soluble matrix. The water-soluble matrix may include native or modified carbohydrates, such as dextrins, maltodextrins, modified starch, such as octenyl succinate modified starch, and gums, such as Gum Arabic; sugar alcohols, such as such as mannitol, xylitol and erythritol; glucanes, chitosan, native or modified proteins, such as gelatin, casein, and protein hydrolysates; poly(vinyl alcohol-co-vinyl acetate) copolymers; polyvinylpyrrolidone; soluble polyacrylates; poly(sulfonate); and poly(oxyalkylene) homo, diblock and triblock copolymers, such as poly(ethylene oxide-b-propylene oxide) diblock copolymers, and poly(ethylene-oxide-b-propylene-oxide-b-ethylene oxide) triblock copolymers. Both carbohydrate-based and protein-based aqueous matrix components are particularly suitable for flavor applications.

In one embodiment, the water-soluble matrix includes maltodextrins. Suitable maltodextrins may include maltodextrins having dextrin equivalents ranging from 2 to 20 and in another embodiment having dextrin equivalents ranging from 6 to 19, wherein the dextrin equivalent refers to the number of reducing sugar units in the maltodextrin macromolecule. Mixtures of maltodextrins having different dextrin equivalent values may also be used.

In one embodiment, the water-soluble matrix is included in an amount of from about 40% to about 90% by weight; in another embodiment in an amount of from about 50% to about 85% by weight; and in yet another embodiment in an amount of from about 60% to about 75% by weight, relative to the total weight of the water-soluble dried particles.

In one embodiment, water-soluble dried particles also include a plurality of droplets, dispersed in the water-soluble matrix. By “droplet” it is meant droplets having an average size of from about 1 μm to about 20 μm; in another embodiment from about 3 μm to about 15 μm; and in yet another embodiment from about 5 μm to about 15 μm.

In one embodiment, the plurality of droplets comprises at least one volatile active component and a plurality of hydrophobically modified particulate materials. The hydrophobically modified particulate materials may include core particulate material and a hydrophobic ingredient.

In one embodiment, the at least one volatile active component is not restricted to a specific class of molecules. It may refer to a substance, a compound, and/or an ingredient, alone or a mixture thereof. The volatile active components may be characterized by an average of clogP values. In one embodiment, suitable volatile active components may have an average clogP of greater than 2; in another embodiment greater than 2.5 and in yet another embodiment greater than 2,9. In another embodiment, suitable volatile active components may have an average clogP in the range of from about 2 to about 6, or any individual number within the range.

“logP” is defined as the logarithm to base 10 of the octanol/water partition coefficient (P) and is used extensively to describe the lipophilic or hydrophobic properties of an active element, for example, a flavorant or fragrance ingredient. The logP values can also be very conveniently calculated using the fragment approach of Hansch and Leo and given as “clogP”. See A. Leo, Comprehensive Medicinal Chemistry, Vol 4, C. Hansch et al. p 295, Pergamon press, 1990. In the context of the present disclosure, the clogP values of the encapsulated components have been calculated using the software embedded in ChemDraw Ultra software, version 12.0.2.1076 (Cambridesoft Corp.)

In one embodiment, the at least one active component is selected from flavors and fragrances. The terms “flavor or fragrance” encompass flavor or fragrance ingredients or compositions of current use in the flavor and/or fragrance industry, of both natural and synthetic origin. It includes single compounds and mixtures. Specific examples of such flavor or fragrance ingredients may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). The flavoring or perfuming ingredients may be present in the form of a mixture with solvents, adjuvants, additives and/or other components, generally those of current use in the flavors and fragrance industry.

In another embodiment, the at least one volatile active component may be selected from pharmaceuticals, vitamins, herbicides, fungicides, insecticides, detergents, cleaning agents and dyes.

Flavor and fragrance compositions may include a broad variety of mixtures of aromatic and fragrant ingredients, such as terpenes, terpene derivatives, esters, alcohols, ethers, ketones, lactones, aldehydes, anthranilates, nitriles, mercaptans, N- and S-heterocycles and the like.

Examples of suitable flavor ingredients include, but are not limited to, natural flavors, artificial flavors, spices, seasonings, synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavor include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavorants may also include aldehydes and esters such as cinnamyl acetate ((E)-3-phenylprop-2-en-1-yl acetate); cinnamaldehyde ((2E)-3-phenylprop-2-enal); citral diethylacetal ((E)-1,1-dimethoxy-3,7-dimethylocta-2,6-diene), dihydrocarvyl acetate (2-methyl-5-prop-1-en-2-ylcyclohexyl acetate), eugenyl formate ((2S)-1,3,3-trimethylbicyclo[2.2.1]heptan-2-yl acetate), p-methylanisol (1-methoxy-4-methylbenzene), and so forth can be used. Further examples of aldehyde flavourings include acetaldehyde (apple), benzaldehyde (cherry, almond), anisic aldehyde (4-methoxybenzaldehyde) (licorice, anise), cinnamic aldehyde ((2E)-3-phenylprop-2-enal) (cinnamon), citral (E)-3,7-dimethylocta-2,6-dienal), i.e., alpha-citral ((EE)-3,7-dimethylocta-2,6-dienal (lemon, lime), neral, i.e., beta-citral ((EZ)-3,7-dimethylocta-2,6-dienal (lemon, lime), decanal (orange, lemon), ethyl vanillin (vanilla, cream), heliotrope, i.e., piperonal (benzo[d][1,3]dioxole-5-carbaldehyde) (vanilla, cream), vanillin (vanilla, cream), alpha-amyl cinnamaldehyde ((E or Z)-2-benzylideneheptanal) (spicy fruity flavours), butyraldehyde (butanal) (butter, cheese), valeraldehyde (pentanal) (butter, cheese), citronellal (3,7-dimethyloct-6-enal) (modifies, many types), decanal (citrus fruits), aldehyde C-8 (octanal) (citrus fruits), aldehyde C-9 (nonanal) (citrus fruits), aldehyde C-12 (dodecanal) (citrus fruits), 2-ethyl butyraldehyde (2-ethyl butanal) (berry fruits), hexenal, i.e., trans-2 hexenal (berry fruits), tolyl aldehyde (4-methylbenzaldehyde) (cherry, almond), veratraldehyde (3,4-dimethoxybenzaldehyde) (vanilla), 2,6-dimethyl-5-heptenal, i.e., melonal (melon), 2,6-dimethyloctanal (green fruit), and 2-dodecenal (citrus, mandarin), and the like.

Examples of suitable fragrance ingredients include, but are not limited to hex-3-en-1-yl butyrate; 2-methyl-1-phenylpropan-2-yl acetate; 2-methyl-1-phenylpropan-2-yl butyrate; 4-(tert- butyl)cyclohexyl acetate; undecan-2-one; 2-benzylideneoctanal; 3,7-dimethylnona-1,6-dien-3-yl acetate; 3,7-dimethylocta-2,6-dien-1-yl acetate; 3,7-dimethylocta-2,6-dienal; non-6-enal; tridec-2-enenitrile; 1-((1,8a)-1,4,4,6-tetramethyl-2,3,3a,4,5,8-hexahydro-1-5,8a-methanoazulen-7-yl)ethanone; 1-(2,3,8,8-tetramethyl-1,2,3,4,5,6,7,8-octahydronaphthalen-2-yl)ethanone; 1-butoxy-1-oxopropan-2-yl butyrate; 2-methyl-1-phenylpropan-2-ol; allyl 2-(isopentyloxy)acetate; allyl 3-cyclohexylpropanoate; methyl non-2-ynoate; undec-9-enal; 1,3,4,5,6,7-hexahydro-.beta.,1,1,5,5-pentamethyl-2-2,4a-ethanonaphthalene-8-ethanol; 1-(1-ethoxyethoxy)hex-3-ene; 1-(2,6,6-trimethylcyclohex-3-en-1-yl)but-2-en-1-one; 1-(2,6,6-trimethylcyclohexa-1,3-dien-1-yl)but-2-en-1-one; 1,1-diethoxy-3,7-dimethylocta-2,6-diene; 2-ethyl-4-(2,2,3-trimethylcyclopent-3-en-1-yl)but-2-en-1-ol; 3,7-dimethylnona-1,6-dien-3-ol; 3,7-dimethylocta-2,6-dien-1-yl isobutyrate; 3-methyl-2-(pent-2-en-1-yl)cyclopent-2-enone; 4-(2,5,6,6-tetramethylcyclohex-2-en-1-yl)but-3-en-2-one; 4-(2,6,6-trimethylcyclohex-1-en-1-yl)but-3-en-2-one; 4-(2,6,6-trimethylcyclohex-2-en-1-yl)but-3-en-2-one; 1,3,3-trimethylbicyclo [2.2.1]heptan-2-yl acetate; (2,4)-1,7,7-trimethylbicyclo[2.2.1]heptan-2-yl acetate; (ethoxymethoxy)cyclododecane; 1-(2,6,6-trimethylcyclohexa-1,3-dien-1-yl)but-2-en-1-one; 3,4,5,6,6-pentamethylhept-3-en-2-one; 3,7,11-trimethyldodeca-1,6,10-trien-3-yl acetate; 3,7-dimethylocta-2,6-dien-1-ol ; 3,7-dimethylocta-2,6-dienal; 3-methyl-5-(2,2,3-trimethylcyclopent-3-en-1-yl)pent-4-en-2-ol; 3-methylcyclotetradec-5-enone; 4-((3a,7a)-hexahydro-1-4,7-methanoinden-5(6)-ylidene)butanal; 4-(2,6,6-trimethylcyclohex-2-en-1-yl)but-3-en-2-one; 4,11,11-trimethyl-8-methylenebicyclo[7.2.0]undec-4-ene; 4-methyldec-3-en-5-ol; 5-methylheptan-3-one oxime; methyl non-2-enoate; oxacyclohexadec-12-en-2-one; 1-42-(tert-butyl)cyclohexyl)oxy)butan-2-ol; 1-(3,3-dimethylcyclohex-1-en-1-yl)pent-4-en-1-one; 1,2,4)-1,3,3-trimethylbicyclo[2.2.1]heptan-2-ol; 1,2,4)-2′-isopropyl-1,7,7-trimethylspiro[bicyclo[2.2.1]heptane-2,4′-[1,3]dioxane]; 1,2,5)-2-ethoxy-2,6,6-trimethyl-9-methylenebicyclo[3.3.1]nonane; 112) (4-(4-hydroxyphenyl)butan-2-one; 1-methyl-2-(5-methylhex-4-en-2-yl) cyclopropyl)-methanol; 1-methyl-4-(4-methylpent-3-en-1-yl)cyclohex-3-enecarbaldehyde; 1-methyl-4-propan-2-ylcyclohexa-1,4-diene; (1s,4s)-1,3,3-trimethyl-2-oxabicyclo [2.2.2]octane; 2-(4-methylcyclohex-3-en-1-yl) propan-2-yl acetate; 2)-ethyl 3-isopropylbicyclo[2.2.1]hept-5-ene-2-carboxylate; 2,2-dimethoxyethyl)benzene; 2,6)-3,7-dimethylnona-2,6-dienenitrile; 2,6-dimethyloctan-2-ol; 2-isopropyl-5-methylcyclohexanol; 2-methyl-4-oxo-4-pyran-3-yl isobutyrate; 2-methyl-6-methyleneoct-7-en-2-yl acetate; 3-(4-isopropylphenyl)-2-methylpropanal; 3,5,5-trimethylhexyl acetate; 3,5-dimethylhex-3-en-2-yl)oxy)-2-methylpropyl cyclopropanecarboxylate; 3,7-dimethyloct-6-en-1-yl acetate; 3,7-dimethyloct-6-en-1-yl formate; 3,7-dimethyloct-6-en-1-yl propionate; 3,7-dimethyloct-6-enenitrile; 3,7-dimethylocta-1,6-dien-3-yl acetate; (3a,4,7,7a)-ethyl octahydro-1-4,7-methanoindene-3a-carboxylate; (3a,6,7a)-3a,4,5,6,7,7a-hexahydro-1-4,7-methanoinden-6-yl acetate; (3a,6,7a)-3a,4,5,6,7,7a-hexahydro-1-4,7-methanoinden-6-yl isobutyrate; (3a,6,7a)-3a,4,5,6,7,7a-hexahydro-1-4,7-methanoinden-6-yl propionate; (3-methyl-2-pentylcyclopent-2-enone; 4,7-dimethyloct-6-en-3-one; 4-methylene-2-phenyltetrahydro-2-pyran; 6,6-dimethoxy-2,5,5-trimethylhex-2-ene; allyl heptanoate; cyclohexyl 2-hydroxybenzoate; ethyl 2,6,6-trimethylcyclohexa-1,3 -diene-1-carboxylate; ethyl heptanoate; ethyl hexanoate; hexyl isobutyrate; pentyl 2-hydroxybenzoate; propanedioic acid 1-(1-(3,3-dimethylcyclohexyl)ethyl) 3-ethyl ester; 3-methyl-4-(2,6,6-trimethylcyclohex-2-en-1-yl)but-3-en-2-one; 1-(3,3-dimethylcyclohexyl)ethyl formate; 1-(3,5,5,6,8,8-hexamethyl-5,6,7,8-tetrahydronaphthalen-2-yl)ethanone; 1-(spiro[4.5]dec-6-en-7-yl)pent-4-en-1-one; 1,1,2,3,3-pentamethyl-2,3,6,7-tetrahydro-1-inden-4(5)-one; decanal; 2-methyldecanal; undec-10-enal; undecanal; 2-methylundecanal; 1-methyl-4-(prop-1-en-2-yl)cyclohex-1-ene; 1-methyl-4-(prop-1-en-2-yl)cyclohex-1-ene; 1-methyl-4-(propan-2-ylidene)cyclohex-1-ene; 2-(isopropyl 2-methyl butanoate; 2-(1-(3,3-dimethylcyclohexyl)ethoxy)-2-methylpropyl cyclopropanecarboxylate; 2-(2-(4-methylcyclohex-3-en-1-yl)propyl)cyclopentanone; 2-(2,4-dimethylcyclohexyl)pyridine; 2-(sec-butyl)cyclohexanone; 2-(tert-butyl)cyclohexyl acetate; 2,2,2-trichloro-1-phenylethyl acetate; 2,2,5-trimethyl-5-pentylcyclopentanone; 2,2-dimethyl-2-pheylethyl propanoate; 2,4,6-trimethyl-4-phenyl-1,3-dioxane; 2,4,6-trimethylcyclohex-3-enecarbaldehyde; 2,6,10-trimethylundec-9-enal; 2,6-dimethylhept-5-enal; 2,6-dimethylheptan-2-ol; 2-cyclohexylidene-2-(o-tolyl)acetonitrile; 2-cyclohexylidene-2-phenylacetonitrile; 2-ethyl-methyl-(m-tolyl)butanamide; 2-isopropyl-5-methylcyclohexanone; 2-methyl-4-methylene-6-phenyltetrahydro-2-pyran; 2-methyldecanenitrile; 2-pentylcyclopentanone; 3-(3-isopropylphenyl)butanal; 3-(4-(tert-butyl)phenyl)-2-methylpropanal; 3-(4-ethylphenyl)-2,2-dimethylpropanal; 3-(4-isobutyl-2-methylphenyl)propanal; 3-(4-isobutylphenyl)-2-methylpropanal; 3,7-dimethyloct-6-en-1-ol; 3,7-dimethyloct-6-enal; 3,7-dimethylocta-1,6-dien-3-ol; 3,7-dimethyloctan-3-ol; 4-(4-methylpent-3-en-1-yl)cyclohex-3-enecarbaldehyde; 4-(tert-pentyl)cyclohexanone; 4,4a,5,9b-tetrahydroindeno[1,2-d][1,3]dioxine; 4-cyclohexyl-2-methylbutan-2-ol; 5-(sec-butyl)-2-(2,4-dimethylcyclohex-3-en-1-yl)-5-methyl-1,3-dioxane; 5-tert-butyl-2-methyl-5-propyl-2-furan; 6-(sec-butyl)quinoline; 6,8-dimethylnonan-2-ol; 6-ethyl-3-methyloct-6-en-1-ol; 8-(sec-butyl)-5,6,7,8-tetrahydroquinoline; 8,8-dimethyl-1,2,3,4,5,6,7,8-octahydronaphthalene-2-carbaldehyde; allyl 2-(cyclohexyloxy)acetate; dec-4-enal; dec-9-en-1-ol; dodec-2-enal; dodecanal; dodecanenitrile; ethyl 2-ethyl-6,6-dimethylcyclohex-2-enecarboxylate; ethyl 2-methylpentanoate; ethyl octanoate; hex-3-en-1-yl methyl carbonate; hexyl 2-hydroxybenzoate; methyl 3-oxo-2-pentylcyclopentaneacetate; oxacyclohexadecan-2-one; and the like.

The water-soluble dried particles may include from about 10% to about 60%, in another embodiment from about 15% to about 50%, in yet another embodiment from about 20% to about 40%, or any individual number within the range, by weight of the particle of at least one volatile active component. In one embodiment, the level of free active component, (i.e. surface oil level) is lower than about 1.5%, in another embodiment lower than about 1%, in another embodiment lower than about 0.3% and in yet another embodiment lower than about 0.15% by weight of the water-soluble dried particles.

According to the present disclosure, core particulate material may be any solid particulate material that is insoluble in water. Suitable core particulate materials include, but are not limited to, water-insoluble materials such as minerals, for example, silicate, talcum, calcium carbonates, clays, and the like or vegetable materials, for example, microcrystalline cellulose, corn cob, and the like. In one embodiment, the average particle size of the core particulate material is less than about 1 μm; in another embodiment, less than about 0.5 μm; in another embodiment less than about 0.25 μm; and in yet another embodiment less than about 0.1 μm. Mixtures of such materials can also be used.

In one embodiment, the core particulate material is a fumed silica, for example Aerosil 200 F® sold by Evonik.

In one embodiment, the relative ratio of core particulate materials, relative to the volatile active component is between about 9:1 and 4:6. In another embodiment, the ratio of core particulate materials to active component is between about 8.5:1.5 and 5:5; in another embodiment between about 8:2 and 6:4.

According to the present disclosure, the hydrophobic ingredient may be a saturated or an unsaturated fatty acid having an alkyl chain with from 8 to 22 carbon atoms; in another embodiment from 10 to 20 carbon atoms and in another embodiment from 12 to 18 carbon atoms. Suitable fatty acids include, but are not limited to octanoic acid (C8), decanoic acid (C10), dodecanoic acid (lauric acid, C12), tetradecanoic acid (C16), octadecanoic acid (C18), oleic acid ((9Z)-Octadec-9-enoic acid), palmitoleic acid ((9Z)-hexadec-9-enoic acid), linoleic acid ((9Z,12Z)-9,12-octadecadienoic acid), and the like.

In one embodiment, the hydrophobic ingredient is oleic acid ((9Z)-Octadec-9-enoic acid).

In one embodiment, the hydrophobically modified particulate material is obtained by applying the liquid hydrophobic ingredient onto the core particulate material in the dry state; that means without the aid of any solvent, diluent or dispersion medium. This is achieved by dry blending. This aspect of the present disclosure is especially surprising, because it cannot be expected by the person skilled in the art, that dry blending of a hydrophobic liquid coating component with a solid, particulate material, will form a free flowing powder, which disperses readily in a mixture of flavor or fragrance oil, water and carbohydrate, under high shear mixing. Typically, one would expect such a combination to form coarse powders, granules or sticky agglomerates which do not disperse easily in a medium.

Surprisingly, it has also been found that blending nanometer-sized particulate material with a liquid fatty acid, in the absence of any solvent, until a solid powder is obtained provides an economical route to the formation of particulate material that is especially suitable for the sake of the above mentioned disclosure. This method avoids the use of large amount of solvents and time-consuming steps, as it is the case prior art processes, such as dispersion process, co-emulsion process or sol-gel process. The possibility of preparing modified nanometer-sized particles in such a simple process was not to be expected based on the prior art.

In one embodiment, as described below, the hydrophobically modified particulate material is dispersed first into the flavor or fragrance composition by gentle mixing in order to form a coarse dispersion and, then, this coarse dispersion is further dispersed in an aqueous medium comprising the carbohydrate matrix material dissolved in it. This provides an oil-in-water emulsion with all components uniformly dispersed.

The oil-in-water emulsion mentioned herein above may be further dried, using known drying processes, such as spray drying, spray coating, fluid bed coating, roll drying, drum coating, blowing, film casting, and the like in order to provide the water-soluble solid particles according to the present disclosure.

The water-soluble dried particles obtained according to the present disclosure are different from classical water-soluble products in that the encapsulated volatile component is present in the form of large droplets and the level of surface oil is minimal. A combination of large droplets and minimal level of surface oil is not possible when using classical emulsifiers, surfactants and protective colloids, such as octenyl succinate modified starch.

The low level of surface oil is also a sign that the volatile ingredients are well trapped in the droplet during drying. Hence, the oil-in-water emulsion according to the present disclosure is particularly suitable as feed emulsion for drying processes involving slow water evaporation rate, such as spray- and fluid-bed coatings, and spray granulation.

### EXAMPLES

The following examples are given solely for the purpose of illustration and are not to be construed as limitations of the present invention, as many variations of the invention are possible without departing from the spirit and scope of the present disclosure. Examples 1 and 2 are emulsions suitable for water-soluble dried particles according to the present disclosure. Example 3 is a comparative.

Emulsions were prepared from the ingredients listed below:

TABLE 1

| Ingredients (wt %) | Example 1 | Example 2 | Example 3 |
|---|---|---|---|
| Water | 50.0 | 50.0 | 50.5 |
| Core particulate Material¹ | 1.0 | 1.0 | |
| Oleic acid | 2.0 | 2.0 | |
| Gum arabic | | | 25.8 |
| Matrix (carrier carbohydrates) | 39.5 | 39.5 | 17.2 |
| Orange flavor | 7.5 | 4.3 | 4.3 |
| Triacetin | | 3.2 | 3.2 |

¹Aerosil 200F by Evonik

Water-soluble dried particles were obtained with the following properties:

Surface oil: 0.2% (Ex. 1); 0.1% (Ex. 2); 0.1% (Ex. 3)

Pre-emulsion droplet size: 8.7 μm (Ex. 1); 1.4 μm (Ex. 2); 2.7 μm (Ex. 3)

Post-emulsion droplet size (dried particles): 9.9 μm (Ex.1); 3.2 μm (Ex.2); 1.4 μm (Ex.3)

Avg. clogP of volatile blend: 3.9 (Ex. 1); 2.0 (Ex. 2); 2.0 (Ex. 3)

Emulsions according to the present disclosure were prepared as follows: 66.7 parts of oleic acid ((9Z)-Octadec-9-enoic acid were dry blended with 33.3 parts of fumed silica particles (Aerosil 200 F, sold by EVONIK), using a blender, for example, a Hobart® planetary mixer, until a free-flowing powder was obtained. Next, the modified particulate material was added to the volatile active component(s) to be emulsified to make a coarse dispersion. The carrier carbohydrates are then dissolved in water. Next, the oily dispersion was added to the water phase containing the dissolved carbohydrates under high shear mixing, for example, IKA mixer, 8000 rpm for five minutes, to create an emulsion. The compositions of the samples are reported on Table 1.

The comparative emulsion as described in Example 3 was prepared as follows: Gum Arabic and carrier carbohydrates were dissolved in water. Orange flavor was combined with triacetin then added to the water phase containing the dissolved gum and carbohydrates under high shear mixing, for example, IKA mixer, 8000 rpm for five minutes, to create an emulsion.

### Dried particles

Some of the above emulsions are then dried into free flowing particles by standard spray drying methods, for example, APV PSD55 wheel atomizing spray dryer. The resulting dry particles where then evaluated in terms of surface oil and droplet size according to standard methods

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Water-soluble dried particles comprising:
a water-soluble matrix; and
a plurality of droplets having an average size of from about 3 μm to about 15 μm, the droplets including
a) at least one volatile active component having an average clogP value of at least 2; and
b) a plurality of hydrophobically modified particulate materials including (i) core particulate material and (ii) a hydrophobic ingredient;
wherein the water-soluble dried particles exhibit a surface oil level of less than 0.3%.

2. The water-soluble dried particles according to claim 1, wherein the water-soluble matrix includes native or modified carbohydrates.

3. The water-soluble dried particles according to claim 1, wherein the water-soluble matrix includes native or modified proteins.

4. The water-soluble dried particles according to claim 1, wherein the at least one volatile active component is selected from flavor and fragrance ingredients.

5. The water-soluble dried particles according to claim 1, wherein the core particulate material is selected from the group consisting of water-insoluble minerals, water-insoluble vegetable materials and mixtures thereof.

6. The water-soluble dried particles according to claim 5, wherein the core particulate material is fumed silica.

7. The water-soluble dried particles according to claim 1, wherein the core particulate material has an average particle size of less than about 1 μm.

8. The water-soluble dried particles according to claim 1, wherein the weight ratio of volative active component to core particulate material is from about 9:1 to about 4:6.

9. The water-soluble dried particles according to claim 1, wherein the hydrophobic ingredient includes a saturated or unsaturated fatty acid having an alkyl chain with from 8 to 22 carbon atoms.

10. The water-soluble dried particles according to claim 9, wherein the hydrophobic ingredient is oleic acid.

11. A delivery system comprising the water-soluble dried particles of claim 1.

12. A consumable comprising the water-soluble dried particles of claim 1.

13. A process for preparing water-soluble dried particles, comprising the steps of:
a) preparing a plurality of hydrophobically modified particulate materials by mixing core particulate material and a hydrophobic ingredient until a free flowing powder is obtained;
b) adding a volatile active component having an average clogP value of at least 2;
c) stirring, agitating or mixing the hydrophobically modified particulate materials and the volatile active component until a coarse dispersion is obtained;
d) preparing a water-soluble matrix including at least a carbohydrate and water;
e) combining the coarse dispersion and the water-soluble matrix under high shear mixing to form an emulsion; and
f) drying the emulsion.

14. The process for preparing water-soluble dried particles according to claim 13, wherein the volatile active component is selected from flavor and fragrance ingredients.

15. The process for preparing water-soluble dried particles according to claim 13, wherein the core particulate material is selected from the group consisting of water-insoluble minerals, water-insoluble vegetable materials and mixtures thereof.

16. The process for preparing water-soluble dried particles according to claim 15, wherein the core particulate material is fumed silica.

17. The process for preparing water-soluble dried particles according to claim 13, wherein the weight ratio of volatile active component to core particulate material is from about 9:1 to about 4:6.

18. The process for preparing water-soluble dried particles according to claim 13, wherein the hydrophobic ingredient includes a saturated or unsaturated fatty acid having an alkyl chain with from 8 to 22 carbon atoms.

19. The process for preparing water-soluble dried particles according to claim 18, wherein the hydrophobic ingredient is oleic acid.

20. The process for preparing water-soluble dried particles according to claim 13, wherein the drying is spray drying.
